(19) United States
(12) Patent Application Publication
(10) Pub. No.: US 2008/0186715 A1
(43) Pub. Date: Aug. 7, 2008

(54) UNDERSHADE APPARATUS

(76) Inventor: SANDRA A. ADAMS, Brookfield, CT (US)

Correspondence Address: MCCORMICK, PAULDING & HUBER LLP, CITY PLACE II, 185 ASYLUM STREET, HARTFORD, CT, 06103, US

(21) Appl. No.: 12/015,976

(22) Filed: Jan. 17, 2008

Related U.S. Application Data
(60) Provisional application No. 60/887,853, filed on Feb. 2, 2007.

(51) Int. Cl. F21V 7/00; F21V 11/00; F21V 17/06

(52) U.S. Cl. 362/310; 362/351; 362/433

(57) ABSTRACT

An undershade apparatus for an illumination assembly having an illumination device mounted within a frame assembly includes a light modifying element suspended adjacent to the illumination device. A suspension assembly is also provided, the suspension assembly being fixed to the frame assembly and the light modifying element. The light modifying element is supported by the suspension assembly.

### CROSS REFERENCE TO RELATED APPLICATIONS

This application claims the benefit of U.S. Provisional Application Ser. No. 60/887,853, filed on Feb. 2, 2007, hereby incorporated by reference in its entirety.

### FIELD OF THE INVENTION

This invention relates, in general, to an undershade apparatus and deals more particularly with an undershade apparatus, which adds utilitarian capabilities as well as ornamental attributes to a wide variety of illumination assemblies.

### BACKGROUND OF THE INVENTION

Illumination assemblies such as household lamps come in a variety of shapes, sizes, and styles. One unifying aspect of lamps resides, however, in that they typically support a light emitting filament or tube surrounded by a protective enclosure, such as a shade.

Shades themselves offer not only a shielding effect from the glare of a bulb but also provide a protective covering to the bulb so as to protect it from potentially harmful contact with people or objects. The shade also obviously provides protection for people against contacting the heated bulb, as is typical with incandescent bulbs.

It is known in the prior art to utilize the shade of a lamp for decorative purposes, such as by forming sections of the shade to be translucent, or to depict a given fanciful scene. It is also known to suspend decorative elements on the outside of the shade in order to give the lamp a more ornamental appearance.

The area within the shade enclosure has not, however, been utilized for such purposes, owing to the historical aversion to placing any items adjacent typically incandescent, and therefore typically hot, bulbs.

With the forgoing problems and concerns in mind, it is therefore a general object of the present invention to utilize the area within the shade enclosure to support an undershade apparatus, which adds utilitarian capabilities as well as ornamental attributes to a wide variety of illumination assemblies.

### SUMMARY OF THE INVENTION

It is an object of the present invention to provide an undershade apparatus, which adds utilitarian capabilities as well as ornamental attributes to a wide variety of illumination assemblies.

It is another object of the present invention to provide an undershade apparatus, which adds utilitarian capabilities as well as ornamental attributes to a lamp.

It is another object of the present invention to provide an undershade apparatus, which adds utilitarian capabilities as well as ornamental attributes to a wall fixture.

It is another object of the present invention to provide an undershade apparatus, which adds utilitarian capabilities as well as ornamental attributes to a ceiling fixture.

It is another object of the present invention to provide an undershade apparatus that provides protection for people against contacting a heated incandescent bulb.

It is another object of the present invention to provide an undershade apparatus that may be releasably attached to a wide variety of illumination assemblies without the need for specialized tools.

It is yet another object of the present invention to provide an undershade apparatus that utilizes the spider portion of a wide variety of illumination assemblies.

It is yet another object of the present invention to provide an undershade apparatus, which adds ornamental attributes that may be customized and personalized by the user.

It is yet another object of the present invention to provide an undershade apparatus that diffuses the light emitted from a light bulb.

It is yet another object of the present invention to provide an undershade apparatus that provides a coloring effect to the glare of a light bulb.

It is yet another object of the present invention to provide an undershade apparatus where the distance between the light bulb and the undershade apparatus may be adjusted to meet the decorative or utilitarian needs of a user.

It is yet another object of the present invention to provide an undershade apparatus that utilizes the area within a shade enclosure.

These and other objectives of the present invention, and their preferred embodiments, shall become clear by consideration of the specification, claims, and drawings taken as a whole.

### BRIEF DESCRIPTION OF THE DRAWINGS

FIG. 1 illustrates an undershade apparatus according to one embodiment of the present invention.

FIG. 2 illustrates another view of the undershade apparatus depicted in FIG. 1.

FIG. 3 illustrates the undershade apparatus depicted in FIG. 1 without a central post from an illumination assembly.

FIG. 4 illustrates the undershade apparatus depicted in FIG. 1 with fanciful elements suspended therefrom.

### DETAILED DESCRIPTION OF THE PREFERRED EMBODIMENT

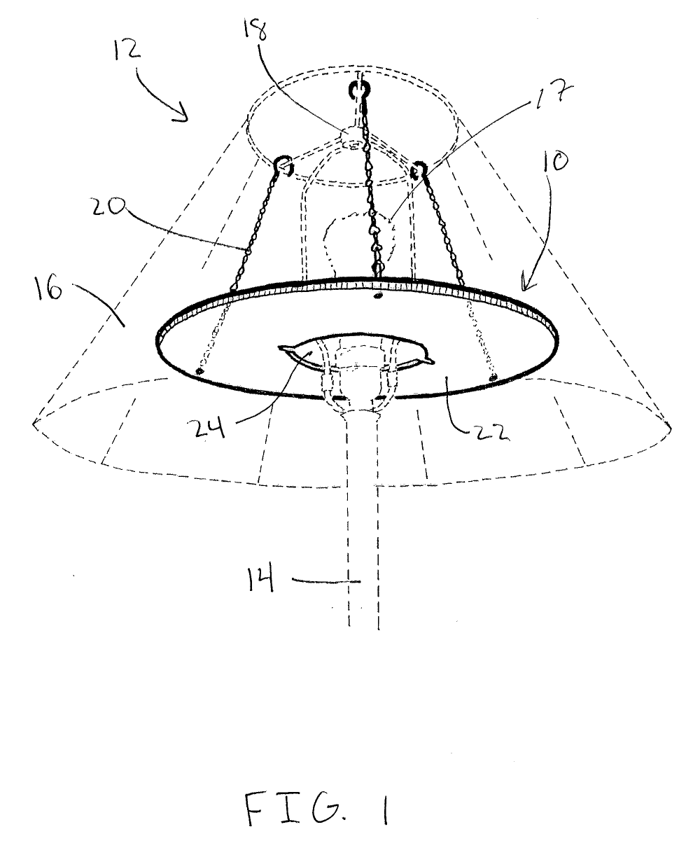

As will be appreciated by a review of FIGS. 1-4 in combination, the undershade apparatus of the present invention is adapted to be suspended within the shade enclosure of an illumination assembly, such as a torchiere or table lamp. Although many of the drawings, descriptions, and examples herein are directed to torchiere or table lamps, the present invention is not so limited. The present invention can be applied to any illumination assembly, such as a ceiling fixture or wall fixture.

FIG. 1 illustrates an undershade apparatus 10 according to one embodiment of the present invention. As can be seen in FIG. 1, the undershade apparatus 10 is attached to an illumination assembly 12. The illumination assembly 12 includes an upright support 14 and a frame assembly. As shown in FIG. 1, the frame assembly is a shade enclosure 16. A spider portion 18 is located at the upper opening of the shade enclosure 16 that allows the shade enclosure 16 to be connected to the illumination assembly 12. The upright support 14 of the illumination assembly 12 is utilized to support the illumination assembly 12 and contains an illumination device such as a light bulb 17.

The undershade apparatus 10 includes a suspension assembly 20. The suspension assembly 20 is releasably fixed to the shade enclosure 16. Shown in FIG. 1, the suspension assembly 20 is preferably releasably fixed to the spider portion 18 of the shade enclosure 16. It will be readily appreciated that although the suspension assembly 20 is shown to be releasably fixed to the spider portion 18, the suspension assembly 20 may be releasably fixed to any part of a frame assembly of the illumination assembly 12. The suspension assembly 20 may also suspend from any separate apparatus made to associate with the shade enclosure 16 or spider portion 18. The suspension assembly 20 may be formed from a metal chain with suitable hook fasteners or may be crafted in any form and from any other material without departing from the broader aspects of the present invention. In addition, the suspension assembly 20 may be permanently attached to the spider portion 18, the shade enclosure 16, or any separate apparatus made to associate with the spider portion 18 or the shade enclosure 16.

Returning to FIG. 1, a light modifying element 22 is suspended from the suspension assembly 20. The suspension assembly 20 may be at positions adjacent the outer periphery of the light modifying element 22. It will be readily appreciated, however, that although there are three suspension lines shown in the drawings to illustrate suspension assembly 20, more or less suspension lines may be alternatively utilized, while the attachment points for the suspension assembly 20 may be spaced apart from the periphery of the light modifying element 22, also without departing from the broader aspects of the present invention.

The light modifying element 22 itself may be formed with an aperture 24. Preferably, the aperture 24 is formed in the approximate center of the light modifying element 22 so as to accommodate and slip over and around the bulb element 17 as well as the upright support 14 of the illumination assembly 12. In addition, the light modifying element 22 may alternatively be formed of two or more sections that can be attached together around the bulb element 17 rather than slipping over the bulb element 17. The light modifying element 22 may also be formed without the aperture 24 for use on a hanging lamp. The light modifying element 22 is preferably formed from a plastic, acrylic, glass, or polymer material, which is clear or at least somewhat translucent. The light modifying element 22 may also be formed with any texture. Indeed, the light modifying element 22 is most preferably formed so as to have an imbued coloration so that operation of the bulb or any illumination device will cause a diffused and colored glow to emanate from the bottom of the shade enclosure 16. Moreover, the light modifying element 22 may be any shape. Preferably and as shown, the light modifying element 22 is a disk.

It is therefore an important aspect of the present invention that the undershade apparatus 10 provides both utilitarian capabilities as well as ornamental attributes. The area within the shade enclosure 16 has historically remained unused, which permits people, especially children, to have unfettered access to a hot, incandescent bulb. The light modifying element 22 of the undershade apparatus 10 creates a barrier to the heated incandescent bulb that provides protection for people against contacting its hot surface. Furthermore, the light modifying element 22 may be colored or textured which creates a colored glow or design emanating from the bottom of the shade enclosure 16, which provides a multitude of ornamental possibilities.

While a colored or clear, plastic, or acrylic light modifying element 22 has been described, the present invention equally contemplates forming the light modifying element 22 from alternative materials, such as metal or wood. These materials still maintain the utilitarian capabilities of the light modifying element 22 by providing a barrier to the hot bulb as described above.

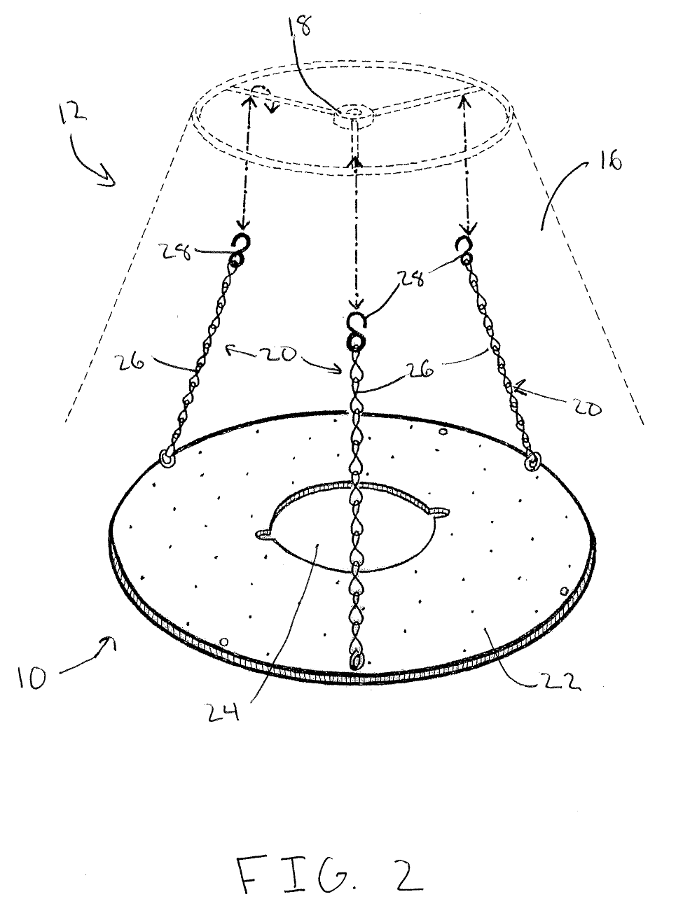

FIG. 2 illustrates how the undershade apparatus 10 may be hung from the shade enclosure 16. It should be readily appreciated that the light modifying element 22 may be suspended from the shade enclosure 16 of the illumination assembly 12 by any given amount, whereby the distance between the top of the shade enclosure 16 and the light modifying element 22 may be adjusted to meet the decorative or utilitarian objectives of a user. As such, the present invention may utilize any area within the shade enclosure 16. As discussed previously, the suspension assembly 20 may include any attaching method. However, as shown in FIG. 2, the suspension assembly 20 includes a chain 26 connected to the light modifying element 22 at one end and a hook fastener 28 at the other end. The hook fastener 28 is designed to releasably attach the suspension assembly 20 to the shade enclosure 16.

As described above, the suspension assembly 20 can be one of many embodiments. The suspension assembly 20 may be crafted in any form and from any material. Furthermore, the suspension assembly 20 may be any length. The hook fastener 28 may be releasably attached to the chain 26 so that the hook fastener 28 can attach to any link of the chain 26, thereby allowing the suspension assembly 20 to be adjustable by the user to any desired length.

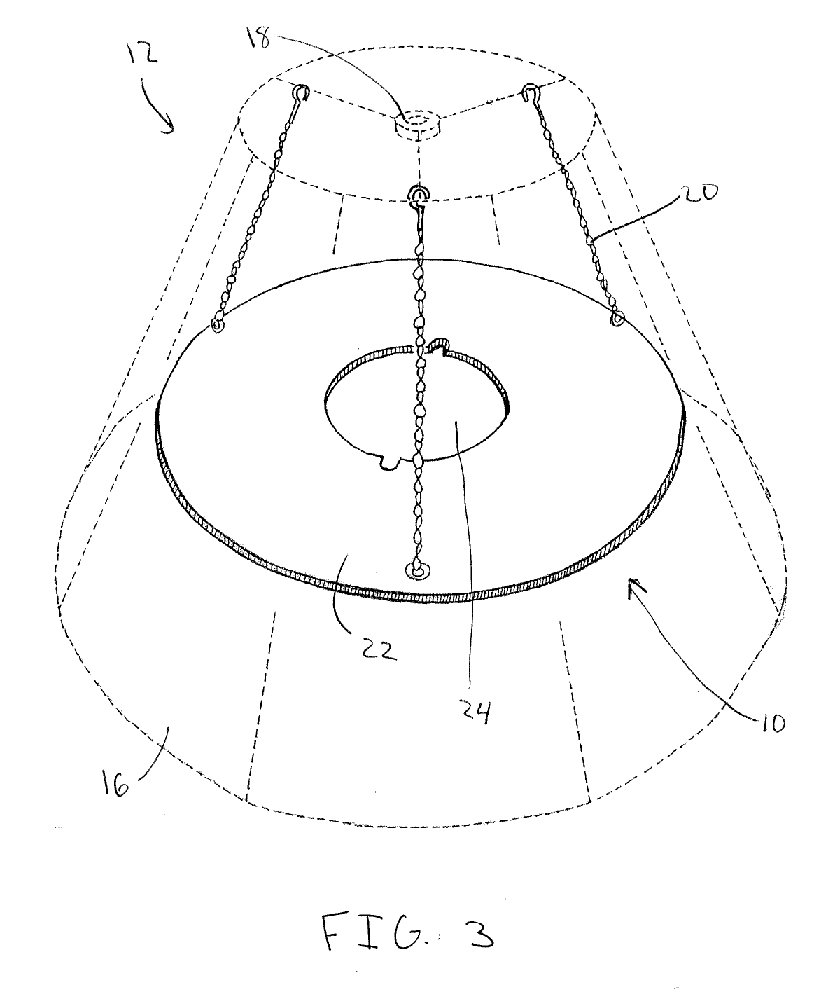

FIG. 3 further illustrates the undershade apparatus 10 but without an upright support of the illumination assembly 12. The undershade apparatus 10 still functions in the same way. The undershade apparatus 10 has a suspension assembly 20, which is releasably attached to the shade enclosure 16. The suspension assembly 20 may also suspend from any separate apparatus made to associate with the shade enclosure 16. A light modifying element 22 is suspended from the suspension assembly 20 at positions adjacent the outer periphery of the light modifying element 22. As shown, the light modifying element 22 is formed with an aperture 24. However, the light modifying element 22 may also be formed without the aperture 24 in any case where the upright support 14 would not interfere with the undershade apparatus 10.

Still further, by employing an alternative embodiment of the present invention whereby the light modifying element 22 has no central aperture 24, the present invention is equally capable of augmenting the appearance and functionality of those illumination assemblies 12 that do not have an upright support 14. That is, the present invention is equally capable of augmenting both wall and ceiling fixtures by suspending the light modifying element 22, with or without a central aperture 24, within the shade enclosure 16 of the illumination assembly 12, and adjacent the illumination device.

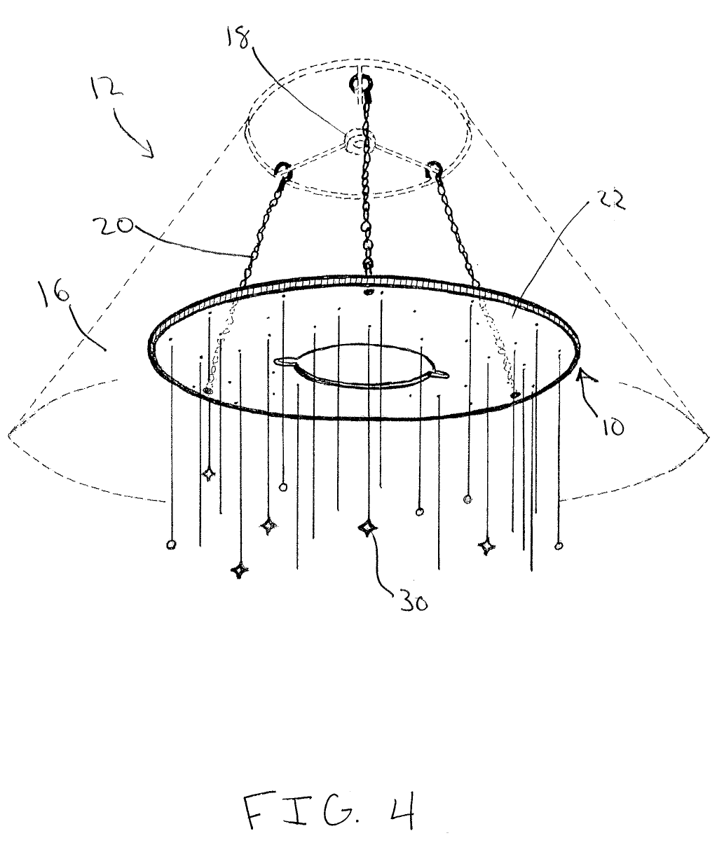

Turning now to FIG. 4, the light modifying element 22 of the present invention may also itself support a variety of fanciful elements 30 suspended therefrom. These fanciful elements 30 may be purely decorative, or may include utilitarian items, without departing from the broader aspects of the present invention. The possibilities for these fanciful elements 30 are endless. The fanciful elements 30 could be permanently attached to the light modifying element 22. In the alternative, the fanciful elements 30 could be releasably attached to provide personalization and customization for the user. These fanciful elements 30 could include collectible items, picture frames for personal photographs, toys, items that reflect the light emanating from the illumination device, or utilitarian items. These fanciful elements 30 add decorative and ornamental attributes to the present invention.

As described above and as illustrated in the combined drawing FIGS. 1-4, the undershade apparatus 10 of the present invention utilizes the heretofore unused area within the shade enclosure 16 of an illumination assembly 12. Moreover, by positioning the light modifying element 22 within the shade enclosure 16 and adjacent the illumination device, the light modifying element 22 is capable of diffusing the light emitted from the illumination assembly 12, while selectively changing the coloration of the light emanating from the shade enclosure 16. The suspension of fanciful elements 30 from the light modifying element 22 itself gives the user the ability to personalize the illumination assembly 12 to a degree not currently known in the art.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all equivalent embodiments.

What is claimed is:

1. An undershade apparatus for an illumination assembly having an illumination device mounted within a frame assembly, comprising:
a light modifying element suspended adjacent said illumination device;
a suspension assembly fixed to said frame assembly and said light modifying element; and
wherein said light modifying element is supported by said suspension assembly.

2. The undershade apparatus according to claim 1, wherein said light modifying element is a translucent disk.

3. The undershade apparatus according to claim 1, wherein said light modifying element has a central aperture.

4. The undershade apparatus according to claim 1, wherein said light modifying element is suspended beneath said illumination device.

5. The undershade apparatus according to claim 1, wherein said light modifying element is colored so as to have a tinting associated therewith.

6. The undershade apparatus according to claim 1, wherein said light modifying element is made from one of an acrylic, plastic, and glass.

7. The undershade apparatus according to claim 1, wherein said light modifying element further includes an aperture for suspending fanciful elements therefrom.

8. The undershade apparatus according to claim 1, wherein:
said suspension assembly is positioned adjacent the outer periphery of said light modifying element.

9. The undershade apparatus according to claim 1, wherein:
said light modifying element is opaque.

10. The undershade apparatus according to claim 1, wherein:
said illumination assembly is a lamp.

11. The undershade apparatus according to claim 1, wherein:
said suspension assembly is adjustable to any length.

12. The undershade apparatus according to claim 1, wherein said suspension assembly is formed from a chain with hook fasteners.

13. The undershade apparatus according to claim 1, wherein said frame assembly is a shade enclosure disposed about said illumination device.

14. The undershade apparatus according to claim 1, wherein said frame assembly is a spider portion disposed about said illumination device.

15. The undershade apparatus according to claim 1, wherein said frame assembly is a shade enclosure and a spider portion disposed about said illumination device.

16. The undershade apparatus according to claim 1, wherein said suspension assembly is releasably fixed to said frame assembly and said light modifying element.

17. The undershade apparatus according to claim 1, wherein said suspension assembly is permanently fixed to said frame assembly and said light modifying element.

18. The undershade apparatus according to claim 1, wherein said light modifying element comprises multiple sections releasably attached to each other.
